(19) United States
(12) Patent Application Publication
(10) Pub. No.: US 2003/0192566 A1
(43) Pub. Date: Oct. 16, 2003

(54) Device for automatically cleaning windows

(76) Inventors: Achim Neubauer, Sinzheim-Vormberg (DE); Martin-Peter Bolz, Buehl (DE); Jochen Moench, Sinzheim (DE); Hartmut Krueger, Buehlertal (DE)

Correspondence Address: KENYON & KENYON, ONE BROADWAY, NEW YORK, NY, 10004, US

(21) Appl. No.: 10/221,368

(22) PCT Filed: Dec. 8, 2001
(86) PCT No.: PCT/DE01/04603

(30) Foreign Application Priority Data
Jan. 10, 2001 (DE) 101 00 732.9

(51) Int. Cl. B08B 3/12

(52) U.S. Cl. 134/1; 134/18; 134/52

(57) ABSTRACT

The invention relates to a method and a device for controlling a cleaning device of a vehicle. Said device comprises a sensor device (10) which uses ultrasonic sensors for recognising fixed objects for detecting environmental parameters, such as rain or snow.

### BACKGROUND INFORMATION

The present invention relates to a device for the automatic cleaning of windows according to the species defined in the independent claim. Numerous devices for the automatic cleaning of windows have been known heretofore, for instance from DE 40 06 420 A1. They work according to an optical principle where light from a transmitter is coupled into the windshield, where it is at least partially reflected on the wetted surface and subsequently decoupled to a receiver.

Furthermore, it is known from DE 198 43 563 A1 to detect turbulent spray moisture, raised in the rear of a motor vehicle, with the aid of an ultrasound sensor of a park-pilot system and to adjust the light distribution of the motor vehicle's headlights as a function of the road condition determined therefrom.

### SUMMARY OF THE INVENTION

The device for the automatic cleaning of windshields according to the present invention has the advantage over the related art that only one sensor device will be required in motor vehicles for a number of possible uses if a sensor device is used which is able to emit signals as a function of the distance between it and other stationary objects within its detection range, on the one hand, and of environmental parameters, on the other hand. The sensor device is able to detect solid objects such as other vehicles, walls, poles or pillars, which is advantageous at low vehicle speeds, for instance when parking or in very tight construction areas, but it is also able to detect environmental parameters such as rain, drizzle, snow or hail. The windshield wiper's movements may then be adjusted to these measured results, which is advantageous especially at high vehicle speeds.

The measures specified in the dependent claims yield advantageous further developments and improvements of the features indicated in the main claim.

The sensor device is advantageously designed as an ultrasound sensor since these are reliable, have a long service life and emit signals that are easy to process.

It is particularly advantageous if the sensor device is part of a park-pilot system. These systems utilize ultrasound sensors to estimate the distance between a vehicle and an obstacle, using ultrasound impulses according to the echo-sounding principle, and to issue a warning signal to the driver if a certain critical minimum distance has been exceeded. The sensor can be used simultaneously not only to monitor the road wetness, but especially to detect a precipitation density as well. It is particularly advantageous here that the device for detecting precipitation is required in a motor vehicle primarily when driving at normal traveling speed, while the parking assistance system merely needs to operate when the vehicle moves at walking speed or even slower. The signals from the sensors may thus be dynamically assigned, as a function of the vehicle speed, to the parking-assistance system or to the control device for controlling the cleaning device, without conflicts arising between the two.

It is particularly advantageous in this case if the controller for controlling the cleaning device is connected to other drive-condition detectors. In this way, a maximum number of signals for the drive conditions may be taken into account to control the cleaning device, which further optimizes their function.

It is especially advantageous if the control device, in addition, is connected to a front-windshield rain detector and controls the cleaning device as a function of its signals.

If signals of the vehicle speed, the transmission position and the ambient temperature are transmitted to the control device as drive-condition information, an optimal wiping strategy for the windshield may be determined from these signals. At low vehicle speed, with the reverse gear engaged, the wiping strategy may be determined without taking the sensor signals into consideration, since the sensor system is used as park pilot. At higher vehicle speed, on the other hand, despite the reverse gear being engaged, the wiping strategy may take the signals from the sensor device into consideration since a longer reverse drive is assumed, for instance, on a parking lot. Taking the ambient temperature into account is especially advantageous because the evaporation rate of the moisture on the vehicle's windshield also increases when the temperature rises.

If the sensor device includes integrated signal conditioning, the shields for the connections between the sensor device and the control device are saved, which reduces costs. It is advantageous, above all, to integrate means for signal amplification and/or band-pass filtering, or means for detecting the environmental parameters, such as a thermostat, directly into the sensor device.

If the cleaning device is designed as a wipe-wash system, an existing vehicle may be retrofitted with the device at low cost.

The method according to the present invention as recited in claim 9 has the advantage that it is an efficient and reliable method for controlling a cleaning device. Moreover, the method is easy to implement.

### BRIEF DESCRIPTION OF THE DRAWINGS

An exemplary embodiment of the present invention is represented in the drawings and elucidated in more detail in the following description. The figures show:

FIG. 1 a schematic drawing of the device according to the present invention.

FIG. 2 an ultrasound sensor in a perspective view.

FIGS. 3a and 3b signals of a sensor during rain and drizzle.

### DESCRIPTION OF THE EXEMPLARY EMBODIMENT

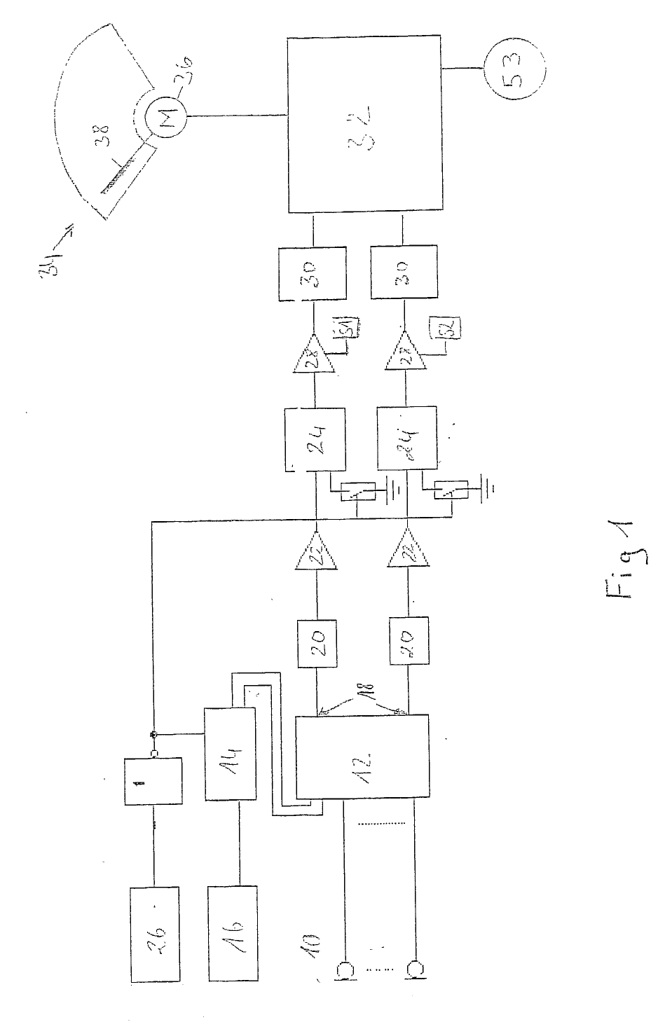

FIG. 1 shows a schematic representation of a device according to the present invention. Sensor device 10 includes a plurality of ultrasound sensors which are part of a park-pilot system of a motor vehicle. As a rule, these park-pilot systems are only active at low speed or in reverse driving—depending on the system—and emit an ultrasound signal. If this ultrasound signal is reflected by solid, in particular non-moving, objects, sensor system 10 will detect this and emit an acoustic or optical signal for the vehicle driver once certain distances between sensor device 10 and the solid, non-moving object have been reached or exceeded. This detection range is normally approximately one meter.

In the device according to the present invention, sensor system 10 is active even during normal vehicle operation, although it will then not emit ultrasound signals; instead, it only receives incoming signals from other signal sources.

Sensor device 10 is connected to a multiplexer 12, which multiplexes the signals of the individual ultrasound sensors onto two output channels 18. For this purpose, multiplexer 12 is connected to a meter 14 which is timed with the aid of a clock generator 16.

Both output channels 18 of multiplexer 12 are connected to one high-pass filter 20 each, which forwards the signal to a respective amplifier 22. The outputs of these amplifiers 22, in turn, are connected to the inputs of integrators 24, which integrate the signal in a timing window of a few μs. For this purpose, integrators 24 have an additional input, which, in time as specified by a further clock timer 26, is set to ground causing a resetting. To synchronize multiplexer 12, meter 14 receives the inverted output signal of further clock generator 26, which also effects the resetting of integrators 24.

The outputs of integrators 24 are connected to comparators 28, which compare these summed-up or integrated signals to thresholds S1, S2, respectively. At the output of these comparators, the signal is supplied to control device 32 with the aid of monostable elements 30. The output of control device 32 is connected to cleaning system 34. The latter has a wiper motor 36 whose driven shaft is connected, indirectly or directly, to a windshield wiper 38.

In the following, the functioning of the device is described.

Sensor system 10 emits signals which are processed by multiplexer 12. Typically, eight ultrasound sensors are utilized, four of which are installed in the front of the vehicle, and an additional four at the rear of the vehicle. Via two output channels 18, these signals are supplied to high passes 20, which filter out any direct-voltage level and low-frequency interference pulses that may be present. The signal is then amplified by amplifiers 22 and supplied to integrators 24. Over an additional time span specified by additional clock generator 26, the signal supplied to integrators 24 is integrated. After this time span has elapsed, integrators 24 are reset again and the integrated signal is forwarded to comparators 28. They compare the integrated signals to thresholds S1 and S2. However, the integrated composite signals may also be processed in additional steps or be directly supplied to control device 32, which is able to control cleaning system 34 as a function of these input signals.

FIG. 2 shows a schematic representation of an ultrasound sensor with an open housing. Basically, it is made up of a printed-circuit board 40 on which an IC 42 is located. On the side facing the detection range, the printed-circuit board is connected to a piezoelement 45 by a flexible foil 43. Also located on printed-circuit board 40 are an adjustment coil 47 and—on the side facing away from flexible foil 43—contact connectors 49. This ultrasound sensor is sheathed in a metal or plastic housing 51 and, typically, is installed in the shock absorbers of a motor vehicle.

Contact connectors 49 have four pins, at one of which an analog signal that is normally present only for measuring purposes is able to be tapped off, as an unamplified and unprocessed signal. This signal gives information about environmental parameters in the detection range of the sensor device. These environmental parameters may be rain or snow, for instance, or also spray water which has been raised by the wheels of the motor vehicle.

If IC 41 of the ultrasound sensor includes an amplification component and appropriate band-pass filters for eliminating low-frequency interference effects, and if IC 41 integrates and digitizes the signal, it is possible, at relatively low cost, to bring an signal out of housing 51 that is easy to use and which may be transmitted from sensor device 10 in the vehicle bumpers to control device 32, without a protective shield being required.

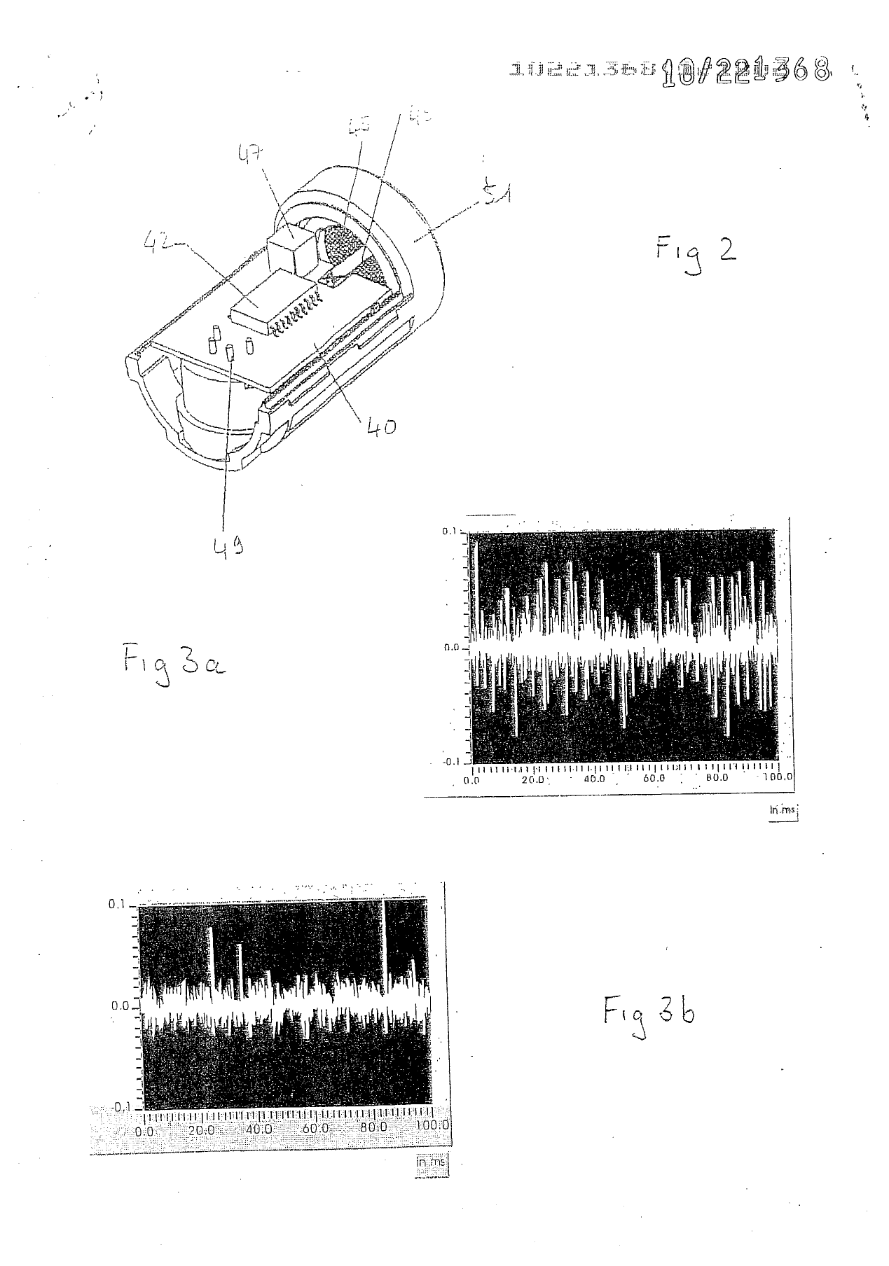

FIGS. 3a and 3b show the signal, which is tapped at contact connectors 49, for two different situations.

FIG. 3a shows the signal of an ultrasound sensor above the time when rain is present, the signal being characterized by many individual needle peaks. FIG. 3b shows the same signal for drizzle/spray, which has only a few individual needle peaks over some noise.

Moreover, control device 32 may also be connected to other drive-condition information sensors 53, which provide control device 32 with information about the drive conditions, such as the ambient temperature, especially as a measure for the evaporation rate, the vehicle speed or other related aspects. Control device 32 takes this drive-condition information into consideration for controlling cleaning system 34.

Ideally, control device 32, in a vehicle-specific manner, calculates the amount of water that will reach the vehicle windshield as a function of the amplitude spectrum of the signal from sensor device 10, the signal intensity and the vehicle speed.

As a rule, it is particularly important to take the vehicle speed into consideration when estimating the wetting of the windshield. The droplet precipitation on the rear window of the vehicle increases as the size of the droplets gets larger.

At very low temperatures, for instance when snow or ice are raised in the form of turbulent spray, it is possible that no wiping may be required although sensor system 10 emits signals to this effect.

Moreover, it is possible to integrate a torrent detection into the control device, so that suddenly appearing water torrents from a passing truck, for instance, may be detected before they reach the vehicle windshield. For this purpose, additional ultrasound sensors could be located along the sides of the vehicle.

What is claimed is:

1. A device for the automatic cleaning of windows, in particular the rear windshield of a motor vehicle, comprising:
a cleaning system (34);
a control device (32) controlling the cleaning system (34),
wherein a sensor device (10) is provided, which is connected to the control device (32) for controlling the cleaning system (34) and is able to emit signals that are a function of the distances between it and other solid, in particular stationary, objects within its detection range, and of environmental parameters.

2. The device as recited in claim 1, wherein the sensor device (10) is designed as an ultrasound sensor.

3. The device as recited in claim 2, wherein the ultrasound sensor (10) is part of a park-pilot system.

4. The device as recited in one or more of the preceding claims, wherein the control device (32), for controlling the cleaning system (34) is connected to additional drive-condition information sensors (56).

5. The device as recited in one or more of the preceding claims, wherein the control device (32) is connected to a front-windshield rain sensor and controls the cleaning system (34) as a function of its signals.

6. The device as recited in claim 4, wherein the control device (32) takes into account as drive-condition information signals reflecting the vehicle speed, the position of the transmission of the vehicle as well as the ambient temperature.

7. The device as recited in one or more of the preceding claims, wherein the sensor device (10) has integrated signal-conditioning, in particular signal amplification and/or filtering, to detect the environmental parameters, especially spray water.

8. The device as recited in one or more of the preceding claims, wherein the cleaning system (34) is designed as a wipe-wash system.

9. A method for controlling a cleaning system (34), in particular for cleaning the windshields of a motor vehicle, comprising at least the following steps:
emission of at least one precipitation-dependent signal by an ultrasound sensor (10);
processing of the signal over a specified time interval;
comparing the processed signal to at least one threshold;
release of an operating signal to the cleaning system (34) when at least one of the at least one thresholds is exceeded or undershot.
